(19) United States
(12) Patent Application Publication
(10) Pub. No.: US 2014/0093095 A1
(43) Pub. Date: Apr. 3, 2014

(54) POROUS COVER STRUCTURES FOR MOBILE DEVICE AUDIO

(71) Applicant: NOKIA CORPORATION, Espoo (FI)

(72) Inventors: Thomas Benedict Slotte, Turku (FI); Markku Oksman, Turku (FI)

(73) Assignee: NOKIA CORPORATION, Espoo (FI)

(21) Appl. No.: 13/630,489

(22) Filed: Sep. 28, 2012

(51) Int. Cl. H04R 1/02

(52) U.S. Cl. 381/87

(57) ABSTRACT

A method is provided according to an example embodiment of the present invention for providing a porous cover structure for a mobile device for use with integrated audio components. Sound inlets and/or outlets in a mobile device cover may be replaced by one or more areas of microholes which are small enough to be invisible or almost invisible to the naked eye. The porous region may be located and dimensioned in a way that provides the best compromise between industrial design, mechanics, and audio requirements. Further, the audio component mechanics beneath the cover may be modified to take additional advantage of the porous cover structure, and the porous structure may also be used as an improved dust and liquid protection feature. A corresponding housing component and apparatus are also provided.

### TECHNOLOGICAL FIELD

An example embodiment of the present invention relates generally acoustical and/or mechanical integration of audio components in mobile devices.

### BACKGROUND

Mobile devices often comprise audio components (e.g. speakers, microphones) integrated within the device. Such integration of the audio components requires consideration of the mechanical and acoustic properties of the components that may at times conflict with the desired industrial design for the mobile device. One of the most visible considerations relates to sound outlets and/or inlets of a mobile device. Such sound outlet design is important because the sound outlet has to be designed in such a way that all acoustic requirements are considered yet it should have an appropriate visual effect so that the overall look of the mobile device is not negatively influenced. A traditional approach has been to create a small number of quite large holes (e.g. around 1 mm diameter) in front of the earpiece and/or microphone of a mobile device. In some cases, additional dust and water protection membranes are attached to such holes to protect the device against dust and water intrusion.

However, such approaches fail to address conflicting requirements of industrial design and audio performance: how to provide good acoustic design without interfering with industrial design. Industrial design trends call for minimalist design with small (and few) sound inlets and outlets for loudspeakers and microphones. This trend conflicts with audio requirements that often call for large and/or inconveniently located sound inlets and outlets that interfere with the aesthetics of the mobile device.

### BRIEF SUMMARY

A method is provided according to an example embodiment of the present invention for providing a porous cover structure for a mobile device for use with integrated audio components. Sound inlets and/or outlets in a mobile device cover may be replaced by one or more areas of microholes which are small enough to be invisible or almost invisible to the naked eye. The porous area is located and dimensioned in a way that provides the best compromise between industrial design, mechanics, and audio requirements. Further, the audio component mechanics beneath the cover may be modified to take additional advantage of the porous cover structure, and the cover may be used as an improved dust and liquid protection feature.

In one embodiment, a method is provided that at least includes providing a housing material having one or more porous regions, the porous regions comprising a plurality of microholes that do not appear visible, and providing one or more audio components adjacent to and/or acoustically coupled to at least one of the one or more porous regions, wherein the one or more porous regions preferentially allow the transmission of sound through the one or more porous regions relative to other portions of the housing material.

In some embodiments, the diameter for microholes comprising a porous region may be determined based upon desired acoustic and/or mechanical characteristics, and for example, such diameter may range from 0.01 mm up to 0.5 mm. In some embodiments, the one or more porous regions may have characteristics that are selected to provide a predetermined acoustic response. In some embodiments, the selected porous region characteristics may include one or more of diameter, area, pitch, thickness, pitch/diameter ratio, porous area, total open area or relative open area.

In some embodiments, the porous cover part may be implemented as a combined sandwich of a dust mesh, and one or more layers of a stiff but acoustically transparent material that gives high mechanical rigidity, and such layered structure may then be molded into a mobile device cover. In some embodiments, the porous cover part may also be implemented as an array of very small openings drilled by laser. In other embodiments, the porous cover part may be implemented by machining an array of very small openings into the mobile device cover. In another example embodiment, the porous cover part may comprise a rigid sintered material, where pores are small enough to be more or less invisible. Further methods or combinations may also be used to produce a rigid or semi-rigid but porous structure where individual pores are essentially invisible or almost invisible.

In some embodiments, a porous region may fit within an area covered by a gasket and an audio component inside a mobile device cover. In some embodiments, a porous region may extend beyond an area covered by a gasket and an audio component positioned within a mobile device cover.

In another embodiment, a housing component is provided comprising a housing material, and one or more porous regions within the material, the porous regions comprising a plurality of microholes that do not appear visible, wherein the one or more porous regions preferentially allow the transmission of sound through the one or more porous regions relative to other portions of the housing material.

In another embodiment, an apparatus is provided comprising at least one audio transducer configured to process an audio signal; and a housing component comprising a housing material, and one or more porous regions within the material, the porous regions comprising a plurality of microholes that do not appear visible, wherein the one or more porous regions preferentially allow the transmission of sound through the one or more porous regions relative to other portions of the housing material; and wherein the at least one audio transducer is located adjacent to at least one of the one or more porous regions.

### BRIEF DESCRIPTION OF THE DRAWINGS

Having thus described certain embodiments of the invention in general terms, reference will now be made to the accompanying drawings, which are not necessarily drawn to scale, and wherein:

FIG. 1 shows a cross section of a typical sound outlet design of a mobile device case;

FIG. 2 shows a sound outlet configured in accordance with an example embodiment of the present invention;

FIG. 3 shows a sound outlet configured in accordance with an example embodiment of the present invention;

FIG. 4 shows a sound outlet configured in accordance with an example embodiment of the present invention;

FIG. 5 illustrates an improvement provided in accordance with an example embodiment of the present invention;

FIG. 6 illustrates a simulated comparison of free-field frequency response in accordance with an example embodiment of the present invention; and

FIG. 7 illustrates a cross section of the example constructions simulated in the comparison of FIG. 6.

### DETAILED DESCRIPTION

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout.

Mobile devices often comprise audio components (e.g. speakers, microphones) integrated within the mobile device. Such integration of the audio components requires consideration of the mechanical and acoustic properties of the components that may at times conflict with the desired industrial design (e.g. desired look) for the mobile device. In typical devices, sound outlets and/or inlets in a mobile device cover generally consist of one or more quite large holes that may impact the desired design of the mobile device (a typical microphone sound inlet may comprise a single hole having a diameter of e.g. 0.8 mm, a typical earpiece sound outlet may comprise a single opening having a dimension of e.g. 1 mm×5 mm, and a typical loudspeaker sound outlet may comprise e.g. 10-20 holes having diameters of e.g. 0.5-1.5 mm).

In embodiments of the present invention, sound outlets and/or inlets are freed from some traditional restrictions of industrial design and may be placed more optimally and/or cover larger areas. In example embodiments, traditional sound outlets and/or inlets in the mobile device cover may be replaced by one or more areas of microholes that are small enough to be invisible or almost invisible to the naked eye. For example, the microholes may be invisible or substantially invisible to a user (e.g. invisible to the naked eye) when the device is viewed at typical distances from a user's eyes during normal operation. In other words, the substantial invisibility of the microholes allows for the sound outlets/inlets to not appear visible to a user under normal operating conditions of a device. The substantial invisibility of the microholes may be provided by configuring the microholes and the porous regions using parameters such as diameter, pitch (distance between the centers of adjacent microholes), area, etc., and considerations of the type of material and surface finish of a device cover. In some embodiments, the porous regions may be located and dimensioned in such a way as to provide the best compromise between industrial design, mechanics, and audio requirements. Herein, the term “microhole” is used to describe openings such as pores, holes, apertures, micro-apertures or the like, which are invisible or substantially invisible to the naked eye of a user. Further, such openings may be circular or non-circular, for example, slits, elliptic shape openings, or the like, may be provided in some embodiments.

Furthermore, in some embodiments, the audio component mechanics beneath the mobile device cover may be modified to take additional advantage of the porous cover structure, and the porous structure may also provide improved dust and liquid protection features. In some embodiments, since such invisible or nearly invisible outlets and/or inlets can be more optimally located, it is easier to create improved acoustical solutions (e.g. leak tolerance, protection from high sound pressure levels) without adversely affecting mobile device design or dust and liquid protection.

In one embodiment, a method is provided that at least includes providing a housing material having one or more porous regions, the porous regions comprising a plurality of microholes that are substantially invisible, and providing one or more audio components adjacent to or acoustically coupled to at least one of the one or more porous regions, wherein the one or more porous regions preferentially allow the transmission of sound through the one or more porous regions relative to other portions of the housing material.

In some embodiments, the diameter for microholes comprising a porous region may be determined based upon desired acoustic and/or mechanical characteristics, and for example, such diameter may range from 0.01 mm up to 0.5 mm. In some embodiments, the one or more porous regions may also have characteristics that are selected to provide a predetermined acoustic response. In some embodiments, the selected porous region characteristics may include one or more of diameter, area, pitch, thickness, pitch/diameter ratio, porous area, total open area or relative open area, which are further described below.

In some embodiments of the present invention, the one or more porous regions may be implemented as a combined sandwich of a dust mesh and one or more layers of a stiff but acoustically transparent material that provides high mechanical rigidity. Such a layered structure can then be molded into a mobile device cover. If such mobile device cover has a suitably rough surface creating a similar visual appearance as the visible dust mesh, the porous region of the cover appears invisible or nearly invisible to an ordinary user.

In some embodiments, the porous part of a mobile device cover may be implemented as an array of very small (e.g., 0.1-0.2 mm or smaller) openings drilled by a laser. In some embodiments, the porous part of a mobile device cover may be implemented by machining an array of very small (for example, 0.1-0.2 mm or smaller) openings into the mobile device cover. In other example embodiments, the porous part of a mobile device cover may be implemented by using a rigid sintered material, where microholes are small enough to be essentially invisible or almost invisible, a rigid cellfoam, or the like. In addition, further methods or combinations may be used that realize a rigid or semi-rigid but porous structure where individual microholes are substantially invisible or almost invisible. In addition, the device cover may alternatively comprise a flexible material that may bend or stretch (e.g. a material based on nanotechnology) which contains porous regions with microholes that may be invisible or substantially invisible to the naked eye. In some embodiments, the porous regions may be located in the front side, back side, ends, or edges of a mobile device cover.

In some embodiments, a porous region may be configured as a separate component which may then be merged with or affixed to a mobile device cover to provide sound outlets/inlets as appropriate. For example, the sound outlet component may comprise a porous region implemented by a mesh material that may then be merged into a device cover or affixed to a device cover by means such as gluing or ultrasonic welding. The porous region may also be configured in a display window or glass component configured as part of or affixed to a mobile device cover.

In some embodiments, a porous region may fit within an area covered by a gasket and an audio component inside a mobile device cover. In some embodiments, a porous region may extend beyond an area covered by a gasket and an audio component positioned within a mobile device cover.

In another embodiment, a housing component is provided comprising a housing material, and one or more porous regions within the material, the porous regions comprising a plurality of microholes that are substantially invisible, wherein the one or more porous regions preferentially allow the transmission of sound through the one or more porous regions relative to other portions of the housing material.

In another embodiment, an apparatus is provided comprising at least one audio transducer configured to process an audio signal; and a housing component comprising a housing material, and one or more porous regions within the material, the porous regions comprising a plurality of microholes that are substantially invisible, wherein the one or more porous regions preferentially allow the transmission of sound through the one or more porous regions relative to other portions of the housing material; and wherein the at least one audio transducer is acoustically coupled to at least one of the one or more porous regions.

Embodiments of the present invention may provide additional acoustic advantages such as wind shielding for microphones, smoothing of frequency response for IHF loudspeakers, added leak tolerance for earpieces, and the like.

For example, leak tolerance for earpiece design is provided by one or more additional sound outlets in addition to the main sound outlet. However, adding additional visible sound outlets may negatively impact the desired appearance and industrial design of a device. Embodiments of the present invention may, allow for leak tolerant earpiece design by providing additional sound outlets that appear invisible or substantially invisible to a user in addition to the primary sound outlet of the earpiece design. Alternatively, embodiments may also provide for replacing the traditional visible sound outlet with a sound outlet that appears invisible or substantially invisible according to described embodiments.

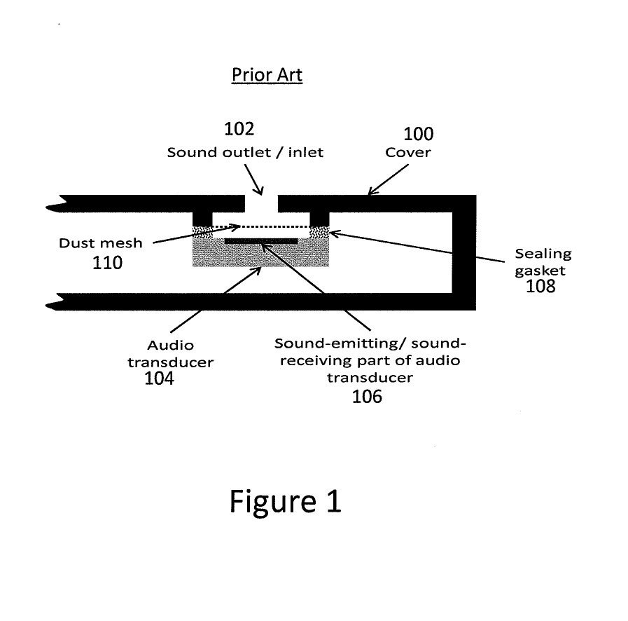

FIG. 1 illustrates a cross-section of a typical mechanical/acoustical integration of an audio component (e.g. microphone, integrated hands-free (IHF) loudspeaker, or earpiece loudspeaker) in a mobile device. The audio component 104 is sealed to the mobile device cover 100 by a gasket 108, and a sound outlet/inlet 102 is provided in the mobile device cover 100. The sound outlet/inlet 102 may generally be located above, or in line with, a sound-emitting/sound-receiving part 106 of the audio component 104. The sound outlet/inlet 102 may consist of a single hole, or several holes. The dust mesh 110 may be used to protect the audio component from dust and water.

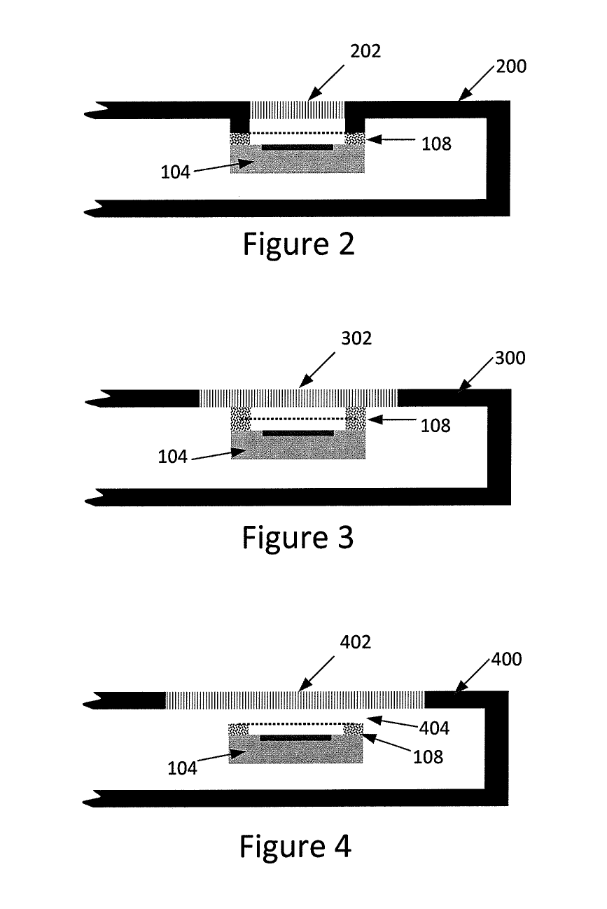

FIGS. 2 through 4 illustrate several example embodiments of the configuration for a porous region as a sound outlet for a mobile device in accordance with some embodiments of the present invention. While FIGS. 2 through 4 are individually illustrated, combinations of the several configurations are also possible. Additionally, a porous area may be configured as a single contiguous region or it may be divided into two or more unconnected regions. Further, while the embodiments illustrated by FIGS. 2 through 4 show a dust mesh, such dust mesh is not required, but is merely shown to illustrate that a dust mesh may also be provided to further enhance dust protection of the mobile device.

An example embodiment of the present invention may now be described as illustrated in FIG. 2, whereby the porous region is sized according to the size of the audio component. In FIG. 2, the audio component 104 (e.g. microphone, integrated hands-free (IHF) loudspeaker, or earpiece loudspeaker) is sealed directly against the mobile device cover 200 using the gasket 108. The porous region 202 of the mobile device cover 200 is constructed so as to fit inside the area enclosed by the gasket 108.

In one example of FIG. 2, the audio component 104 may be a microphone. In such an embodiment, the microphone behaves like a microphone in conventional mobile device mechanics, except that the high-frequency response may be somewhat attenuated. The porous region 202 in the mobile device cover 200 may be somewhat larger than a typical conventional sound inlet for a microphone (e.g. 1-4 mm², the maximum area would generally be defined by the size of the microphone component itself).

In another example, the audio component 104 may be an IHF loudspeaker. In such embodiments, the porous region 202 may typically be at least 10 mm², but it could also be as large as the area the gasket 108 may accommodate (for example, more than 50 mm²).

In another example, the audio component 104 may be an earpiece loudspeaker. In such an embodiment, the porous region 202 may be on the order of 1-10 mm² with the maximum area being defined by the size of the earpiece loudspeaker itself. Further, in some embodiments, if the porous region 202 is sufficiently large, the risk of a user's ear accidently blocking the sound outlet may be reduced.

FIG. 3 illustrates another example embodiment, whereby a porous region larger than an audio component may be provided. In FIG. 3, the audio component 104 is also sealed directly against the mobile device cover 300 using the gasket 108. However, the porous region 302 extends outside the area of the mobile device cover 200 enclosed by the gasket 108. As such, the porous region 302 provides an area outside the physical footprint of the audio component 104 that may be acoustically transparent.

In one example of FIG. 3, the audio component 104 may be an earpiece loudspeaker. In such embodiments, the additional area of porous region 302 outside the gasket 108 can be of the order of 5-10 mm², for example. In some embodiments, a mobile device having a sound outlet configured in the manner of porous region 302 may provide additional advantages related to sound quality. For example, porous region 302 may provide the added advantage of a higher leak tolerance. As such, the sound quality (and more specifically, the level of bass) is less dependent on how tightly the mobile device is pressed against a user's ear. Further, in some embodiments, if the porous region 302 is sufficiently large, the risk of a user's ear accidently blocking the sound outlet may be reduced.

In another example, the audio component 104 may be an IHF loudspeaker. In such embodiments, the porous region 302 may provide better protection of a user's ear against too high sound pressure levels in case the IHF loudspeaker is accidentally activated when held very close to a user's ear (often called “acoustic shock”). In such embodiments, the porous region 302 may be quite large, such as on the order of at least a couple of square centimeters or more. As such, it may become impossible to fully seal the IHF loudspeaker against a user's ear, and thereby avoid potentially causing hearing damage. In some embodiments, a sound outlet configured such as porous region 302 may provide similar advantages for a single speaker configuration where an IHF and earpiece are combined in a single component.

FIG. 4 illustrates an example embodiment, whereby a larger porous region is provided. In FIG. 4, the audio component 104 is not sealed against the mobile device cover 400, but rather a small air space 404 is left open between the audio component 104 and the mobile device cover 400. In some embodiments, the audio component 104 may be acoustically coupled to a porous region but located at a distance from the porous region. In FIG. 4, mobile device 400 is configured with a larger porous region 402 to ensure that the passage of sound to and/or from the audio component 104 is not impeded too much by the acoustic low-pass filter effect caused by the sound outlet (e.g. porous region 402) and the rather large internal air space inside the mobile device.

In one example of FIG. 4, the audio component 104 may be a microphone. In such an embodiment, the porous region 402 in the mobile device cover 400 may be quite large, for example a porous region 402 of a couple of square centimeters or more in front of and around the microphone. In some embodiments, a mobile device having a sound inlet for a microphone configured in the manner of porous region 402 may provide much better wind protection than prior approaches. In such embodiments, the porous region 402 may act as an efficient wind shield, since it is separated from the microphone rather than sealed to it. As a result, recordings and calls may remain clear in more windy conditions. In some embodiments, a sound inlet configured as porous region 402 may provide much less risk of a user accidentally blocking the sound inlet (e.g. with a finger) as the total area of the sound inlet is too large to be easily blocked.

In other examples, the audio component 104 may be an IHF loudspeaker. In such an embodiment, the porous region 402 in the mobile device cover 400 may reduce the risk of having the sound outlet blocked (e.g. when the phone is laid on a table), since the sound outlet (porous region 402) may be made much larger and extend into a wider area than a conventional sound outlet. Additionally, a sound outlet configured such as porous region 402 may provide protection of a user's ear against too high sound pressure levels in case the IHF loudspeaker is accidentally activated when held very close to the ear. By providing a sufficiently large porous region 402 it may become impossible to fully seal the IHF loudspeaker against a user's ear, and thereby avoid potentially causing hearing damage. In some embodiments, a sound outlet configured such as porous region 402 may also provide similar advantages for a single speaker configuration where an IHF and earpiece are combined in a single component.

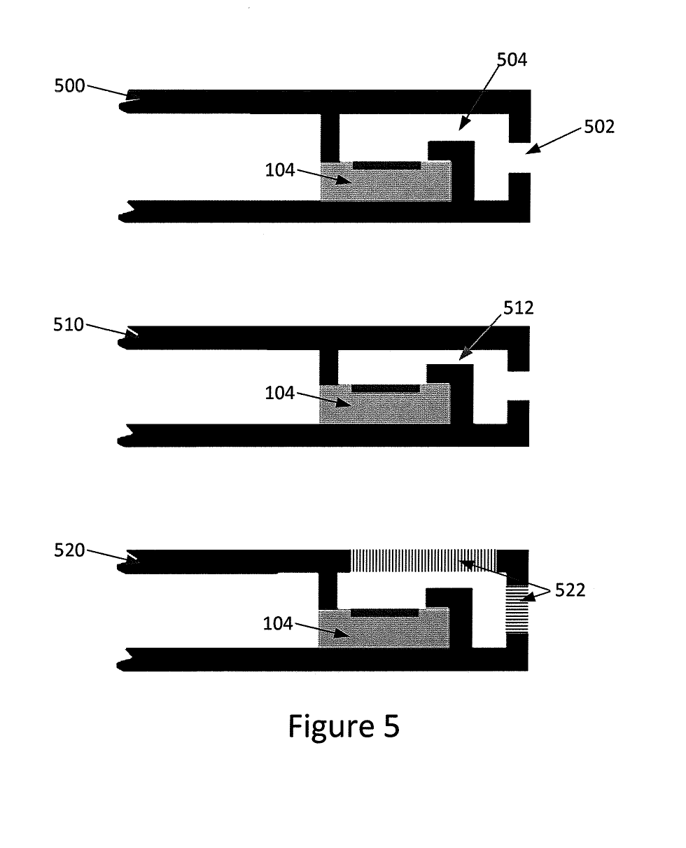

In some embodiments, a mobile device cover configured with sound outlets and/or inlets such as porous region 402 may also allow acoustics to be designed in such a way that it uses less total space inside the mobile device, such as described below in regard to FIGS. 5 through 7.

FIG. 5 illustrates an example of how embodiments of the present invention may benefit both design (device size and look) and audio performance. In some embodiments, the fact that porous regions can be located in areas of a mobile device cover outside of those areas where visible holes may be allowed enables sound outlet location and size to be chosen more wisely from an acoustics standpoint. As such, improved audio performance may be provided for a given mobile device size. While FIG. 5 illustrates one example, other variations are also possible.

FIG. 5 first shows a typical mobile device 500 with a visible sound outlet 502 at the end of the mobile device cover, with the sound outlet acoustically coupled to an audio component 104 via a sound outlet channel 504. In order to reduce the thickness of a mobile device, the mobile device 510 may be configured with a reduced form factor. As a result, the sound outlet channel 512 may be narrowed, thereby leading to a loss of performance (e.g. attenuated high frequencies, loss of sensitivity).

In an example embodiment of the present invention, mobile device 520 may be designed with a reduced thickness. However, by configuring sound outlets using porous regions 522 in place of visible holes, sound outlets may be located outside the regions acceptable for visible holes. As such, a larger total sound outlet/inlet area may be provided and improved sound outlet locations may be used, thereby maintaining the audio performance of the mobile device at a reduced thickness.

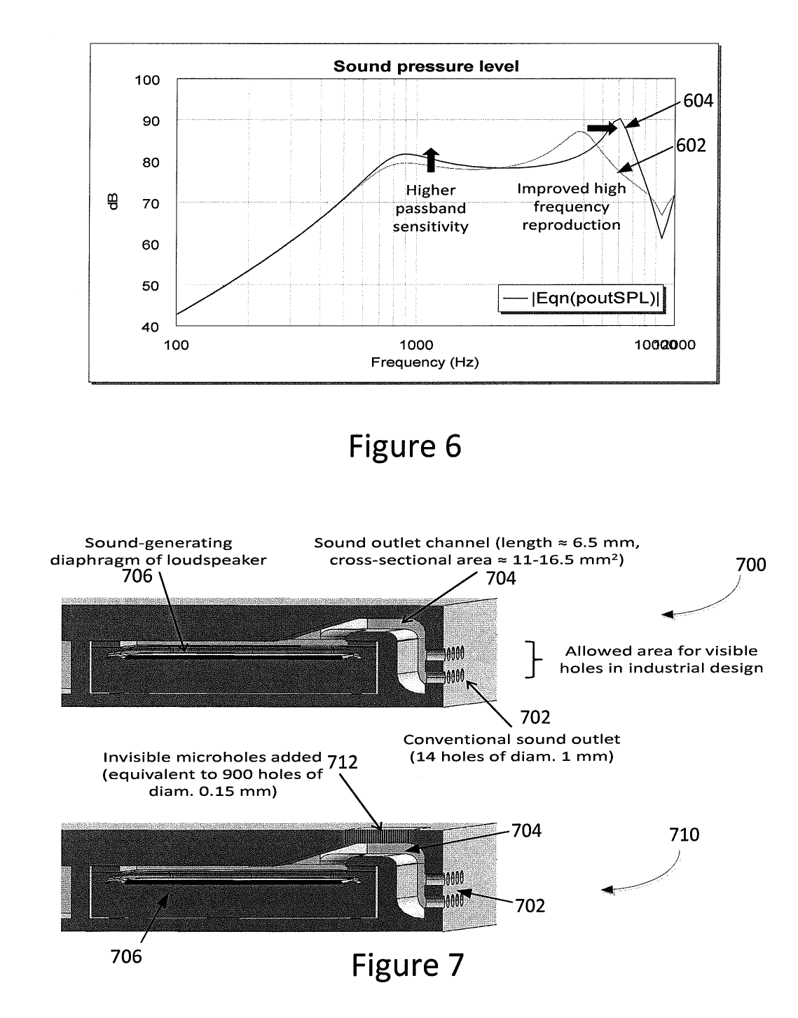

FIG. 6 illustrates a simulated free-field frequency response in graph line 602 of a first mobile device configuration (e.g. device 700 of FIG. 7) where the sound outlet has to be placed at a distance from the loudspeaker due to design constraints. Graph line 604 illustrates a simulated free-field frequency response of a mobile device configuration (e.g. device 710 of FIG. 7) according to an embodiment of the present invention which provides a porous region as an added sound outlet in a better location on the mobile device. The graphs of FIG. 6 illustrate the improved passband sensitivity and high-frequency reproduction provided by the addition of the porous region in accordance with embodiments of the present invention.

FIG. 7 illustrates cross-sections of the two mobile device configurations simulated in FIG. 6. Mobile device 700 is configured with a single traditional sound outlet 702 with a sound outlet channel 704 connecting the sound outlet 702 and the loudspeaker 706. Mobile device 710 is configured with an additional porous region sound outlet 712 in accordance with an example embodiment providing improved audio performance as described above with regard to FIG. 6.

In example embodiments, several parameters may affect the desired properties for the configuration of the sound outlets and/or inlets. As such, these parameters may be selected in order to provide the desired acoustic characteristic and/or frequency response. Some of these parameters may include:
diameter, which is the diameter of each single microhole (which may be assumed constant from one end of the microhole to the other, for simplicity),
area, which is the area of each single microhole (which in the case of circular microholes is simply the area of a circle having the same diameter as the microhole; area can be used as a more meaningful parameter for microholes that are non-circular)
pitch, which is the distance from the center of one microhole to the center of an adjacent microhole,
thickness, which is the thickness of the porous part, which in the case of straight microholes is also equivalent to the actual length of each microhole in the direction of air flow when sound passes through the porous part,
porous area, which is the area of the mobile device cover region that is perforated,
pitch/diameter ratio, which is the ratio of pitch to diameter, and is of course always greater than 1,
total open area, which is the combined area of all microholes, and
relative open area, which is the ratio of total open area to porous area.

It should be noted that the pitch/diameter ratio directly determines how much of each unit area of the mobile device cover is open. Therefore, one can consider “low pitch/diameter ratio” as an equivalent of “large relative open area”, and vice versa.

In some example embodiments, for low visibility (i.e. attractive industrial design), a desired combination may be small diameter and large pitch/diameter ratio (for example, 5:1). In some example embodiments, for good dust protection, a desired configuration may be very small diameter (e.g. 0.05 mm or less) and reasonably small total open area. In some example embodiments, for good acoustical performance (i.e. a low enough acoustic impedance), a desired configuration may be reasonably large diameter (e.g. 0.2 mm), large relative open area, large enough total open area, and small thickness (e.g. 0.5 mm). In some example embodiments, for avoiding a sound outlet and/or inlet getting fully clogged, a desired configuration may be large porous area, large relative open area, and small thickness. In some example embodiments, for mechanical strength, a desired configuration may be large pitch/diameter ratio and large thickness. In some example embodiments, for good liquid protection, the desired configuration may be similar to the dust protection requirements, but where the diameter may be larger.

Various combinations of these configurations may be made to provide many possible design solutions. As one example, for IHFs and earpieces, it may generally be desired that the specific acoustic impedance of the porous region of the mobile device cover not be higher than the specific acoustic impedance of typical dust meshes (and sound outlets) used in existing constructions. For example, some examples of suitable alternatives for IHFs and earpieces may include (a) diameter 0.2 mm, pitch 0.3 mm, thickness 1 mm; (b) diameter 0.15 mm, pitch 0.3 mm, thickness 0.5 mm, etc.

Further embodiments may provide additional features such as hydrophobic (or oleophobic) surface treatment and carefully chosen surface roughness (on the outer surface of the mobile device cover) to reduce visibility of microholes and/or prevent substances from attaching to the microholes and clogging them.

That which is claimed:

1. A method comprising:
providing a housing material having one or more porous regions, the porous regions comprising a plurality of microholes that are substantially invisible, and
providing one or more audio components acoustically coupled to at least one of the one or more porous regions,
wherein the one or more porous regions allow the transmission of sound through the one or more porous regions relative to other portions of the housing material.

2. A method according to claim 1 wherein the microholes have a diameter selected from a range of 0.02 mm up to 0.5 mm.

3. A method according to claim 1 wherein the one or more porous regions have characteristics that are selected to provide a predetermined acoustic response.

4. A method according to claim 3 wherein the porous region characteristics that are selected include one or more of diameter, area, pitch, thickness, pitch/diameter ratio, porous area, total open area or relative open area.

5. A method according to claim 1 further comprising drilling an array of microholes within the one or more porous regions using a laser or machining an array of microholes within the one or more porous regions.

6. A method according to claim 1 wherein the one or more porous regions comprise a dust mesh and one or more layers of a stiff but acoustically transparent material.

7. A method according to claim 1 wherein the one or more porous regions comprise a rigid sintered material.

8. A method according to claim 1 wherein at least one of the porous regions has a size to fit within a gasket sealing one of the one or more audio components to the material.

9. A method according to claim 1 wherein at least one of the porous regions has a size to extend beyond an area within a gasket sealing one of the one or more audio components to the material.

10. A method according to claim 1 wherein at least one porous regions has a size to extend beyond an area proscribed by the size of one of the one or more audio components located adjacent to but not in contact with the material.

11. A housing component comprising:
a housing material, and
one or more porous regions within the material, the porous regions comprising a plurality of microholes that are substantially invisible,
wherein the one or more porous regions allow the transmission of sound through the one or more porous regions relative to other portions of the housing material.

12. A housing component according to claim 11 wherein the microholes have a diameter selected from a range of 0.02 mm up to 0.5 mm.

13. A housing component according to claim 11 wherein the one or more porous regions have characteristics that are selected to provide a predetermined acoustic response.

14. A housing component according to claim 13 wherein the porous region characteristics that are selected include one or more of diameter, area, pitch, thickness, pitch/diameter ratio, porous area, total open area or relative open area.

15. A housing component according to claim 11 wherein the one or more porous regions comprise a dust mesh and one or more layers of a stiff but acoustically transparent material.

16. A housing component according to claim 11 wherein the one or more porous regions comprise a rigid sintered material.

17. A housing component according to claim 11 wherein at least one of the porous regions has a size to fit within a gasket sealing an audio component to the housing component.

18. A housing component according to claim 11 wherein at least one of the porous regions has a size to extend beyond an area within a gasket sealing an audio component to the housing component.

19. A housing component according to claim 11 wherein at least one of the porous regions has a size to extend beyond an area proscribed by the size of an audio component acoustically coupled to but not in contact with the housing component.

20. An apparatus comprising:
at least one audio transducer configured to process an audio signal; and
a housing component comprising:
a housing material, and
one or more porous regions within the material, the porous regions comprising a plurality of microholes that are substantially invisible,
wherein the one or more porous regions allow the transmission of sound through the one or more porous regions relative to other portions of the housing material; and
wherein the at least one audio transducer is acoustically coupled to at least one of the one or more porous regions.
